(19) United States
(12) Patent Application Publication
(10) Pub. No.: US 2011/0187579 A1
(43) Pub. Date: Aug. 4, 2011

(54) METHOD AND DEVICE FOR TRANSMISSION, METHOD AND DEVICE FOR RECEPTION, AND METHOD AND DEVICE FOR DETECTING TARGET OBJECT

(76) Inventors: Yasunobu ASADA, Nishinomiya-City (JP); Hitoshi Maeno, Nishinomiya-City (JP)

(21) Appl. No.: 13/018,194

(22) Filed: Jan. 31, 2011

(30) Foreign Application Priority Data
Feb. 1, 2010 (JP) 2010-020019

(51) Int. Cl. G01S 13/00; H04L 27/00

(52) U.S. Cl. 342/27; 375/295; 375/316

(57) ABSTRACT

This disclosure provides a transmission device, which includes a signal generating module for generating two or more kinds of pulse-shaped signals of mutually different pulse widths, and an antenna for emitting the pulse-shaped signals to the exterior. For the two or more kinds of pulse-shaped signals generated by the signal generating module, an order of two or more kinds of pulse-shaped signals included in a predetermined time frame differs from an order of two or more kinds of pulse-shaped signals included in a different time frame.

### CROSS-REFERENCE TO RELATED APPLICATION(S)

The application claims priority under 35 U.S.C. §119 to Japanese Patent Application No. 2010-020019, which was filed on Feb. 1, 2010, the entire disclosure of which is hereby incorporated by reference.

### TECHNICAL FIELD

The present invention relates to a method and device for transmitting two or more kinds of pulse-shaped signals, a method and device for receiving the transmitted pulse-shaped reflection signals, a target object detection device provided with the transmission device and the reception device, and a method of detecting a target object, including the methods of transmission and reception.

### BACKGROUND

Conventionally, various target object detection devices which detect a target object have been devised. For example, a radar device transmits radio signals to a detection area of a prescribed area and receives reflection signals of the radio signals to form a detection image of the detection area. Such a radar device, as disclosed in JP2656097B and JP2788926B, uses a pulse-shaped signal as a radio signal to be transmitted, in which the pulse-shaped signal is continuously transmitted at a prescribed interval.

Meanwhile, the conventional radar device uses a magnetron which can easily obtain a large transmitting power when generating the pulse-shaped signal to be transmitted. However, instead of the magnetron radar, many solid state radars using semiconductors or the like have been put in practical use in order to comply with current spurious regulations, size reduction, and the like.

In such a solid state radar, because its generable pulse has a smaller amplitude than the magnetron radar, it must have a long pulse width when a large transmitting power is required (e.g., when detecting a distant location). However, the radar device, for performing a transmission and a reception while switching between the transmission and the reception with a single antenna, cannot perform the reception during the transmission. Thus, if the pulse width is longer, more blind area in which reflection signals cannot be received will be produced in an area in the vicinity of the radar device.

For this reason, in order to detect the blind area of the pulse-shaped signal in which the pulse width is wide, a method of using a pulse-shaped signal with a narrow pulse width has been devised. In this method, the pulse-shaped signal with the narrow pulse width is transmitted between the continuous pulse-shaped signals with wide pulse width.

However, in this method, a secondary echo of the pulse-shaped signal which differs in the pulse width transmitted from a ship (which equips the radar) may be received. The secondary echo may have a level which could typically be considered to be a reflection from a target object, and it is obtained from a position where the target object does not exist in fact. Therefore, this may cause a false detection.

### SUMMARY

Therefore, the present invention is made in view of the situations as described above, and enables an accurate and positive target object detection even in a case where the target object detection is performed using two or more kinds of pulse-shaped signals.

According to an aspect of the invention, a transmission device is provided, which includes a signal generating module for generating two or more kinds of pulse-shaped signals of mutually different pulse widths, and an antenna for emitting the pulse-shaped signals to the exterior. For the two or more kinds of pulse-shaped signals generated by the signal generating module, an order of two or more kinds of pulse-shaped signals included in a predetermined time frame differs from an order of two or more kinds of pulse-shaped signals included in a different time frame of the same length.

According to another aspect of the invention, a transmission device is provided, which includes a signal generating module for generating two or more kinds of pulse-shaped signals of mutually different pulse widths, and an antenna for emitting the pulse-shaped signals to the exterior. For the two or more kinds of pulse-shaped signals generated by the signal generating module, a combination of two or more kinds of pulse-shaped signals included in a predetermined time frame differs from a combination of two or more kinds of pulse-shaped signals included in a different time frame of the same length.

In these aspects, the two or more kinds of pulse-shaped signals are not always emitted continuously by the same pattern. Thereby, when receiving echo signals of the two or more kinds of pulse-shaped signals, receiving intervals of the echo signals caused by different kind of pulse-shaped signals can be prevented from always becoming the same.

The two or more kinds of pulse-shaped signals generated by the signal generating module may each use a pulse train including every kind of pulse-shaped signal, as a unit of the predetermined time frame.

This shows more particular configuration which implements the emission of two or more kinds of pulse-shaped signals, and uses a concept of a pulse train having a combination of two or more kinds of pulse-shaped signals. The combination and/or a transmitting order of the pulse-shaped signals are differentiated between the pulse trains.

For example, in a certain pulse train, the pulse-shaped signals are transmitted in order of a short pulse and a middle pulse. Then, in the subsequent pulse train, the pulse-shaped signals are transmitted in order of the middle pulse and the short pulse. Thereby, for example, even for the short pulses which are the same, time intervals of the short signals from reference timings of the respective pulse trains to transmissions of the short pulses are different from each other. Accordingly, timings at which reception signals (echo signals) caused by the same kind of pulse-shaped signals with respect to the reference timings of the respective pulse trains are acquired can be intentionally differentiated.

In one embodiment, the pulse train may include one short pulse and one middle pulse. In another embodiment, the pulse train may include two short pulses and one middle pulse. This setting can also differentiate the time intervals of the same kind of pulse-shaped signals from start timings of the respective pulse trains. Therefore, it can be achieved by simply increasing the number of transmissions of a specific kind of pulse-shaped signals within a pulse train, without shifting the transmission timings of two or more kinds of pulse-shaped signals for each pulse train, or changing the transmitting order of the pulse-shaped signals.

Transmission timing intervals of specific two kinds of pulse-shaped signals may differ in at least one of the two or more pulse trains.

This shows another way of differentiating the timings between the pulse trains. Even with this, the time intervals of the same kind of pulse-shaped signals can be differentiated from the start timings of the respective pulse trains. Thereby, the transmission timings of the pulse-shaped signals can be set more freely.

According to another aspect of the invention, a reception device for receiving echo signals caused by two or more kinds of pulse-shaped signals of mutually different pulse widths and generating reception data is provided. The device includes an antenna for receiving the echo signals, and a reception signal processing module for aligning reference timings of reception data between the same kind of pulse-shaped signals, comparing the reception data between the same kind of pulse-shaped signals, and generating data based on the comparison results.

Even if two or more kinds of pulse-shaped signals are transmitted at random as described above and corresponding echo signals are received, the reference timings of the reception data based on the echo signals are aligned between the same kind of pulse-shaped signals. Then, the reception data for which the reference timings are aligned are compared with each other, and, thereby, secondary echoes can be suppressed based on reproducibility or the like of each reception data. Note that, even if a pulse-shaped signal transmitted from another ship is received, an influence of interference associated with the reception can be suppressed by using this processing.

According to another aspect of the invention, a reception device is provided. Under a condition in which two or more pulse trains where a combination and an order of two or more kinds of pulse-shaped signals of mutually different pulse widths are different from each other being set, the device receives echo signals caused by the two or more pulse-shaped signals transmitted for every pulse train and generates reception data. The reception device includes an antenna for receiving the echo signals, a reception signal processing module, for the reception data of the two or more kinds of pulse-shaped signals of each pulse train, for aligning reference timings of the pulse trains and aligning each reference timing of the reception data of the two or more kinds of pulse-shaped signals that constitute the pulse train with respect to the reference timing of the pulse train, comparing the reception data between the same kind of pulse-shaped signals, and generating data based on the comparison results.

This shows a reception at the time of using the concept of the pulse train for transmission of the two or more kinds of pulse-shaped signals. Even if two or more kinds of pulse-shaped signals are different in the combination or order within a pulse train, the transmission timings of the pulse-shaped signals can be aligned between the pulse trains, and references for comparing the reception signals for respective pulse trains can be aligned. Then, if the reception signals for which the reference timings are aligned are compared, the secondary echoes can be suppressed based on the reproducibility or the like of each reception data. In addition, interference by the pulse-shaped signal from another ship can also be suppressed.

The reception signal processing module may include sweep memories for individually storing the reception data for each pulse train. The reception signal processing module may mutually compare the reception data stored in the respective sweep memories, and generate data based on the comparison results.

This shows a particular configuration of the reception device in which the sweep memories are provided for every pulse train to be compared, and each reception data is stored.

The reception signal processing module may generate data based on the comparison results by adopting representative value data from the two or more reception data caused by the pulse-shaped signals of the same kind to be compared.

This shows a particular way of the comparison processing. By adopting the representative value data of the minimum value data or the like, high level data can be obtained when data of a target object appears at the same distance position continuously for every pulse train. If the data is a secondary echo or interference, it will be suppressed by low level data.

According to another aspect of the invention, a target object detection device is provided. The device emits two or more kinds of pulse-shaped signals of mutually different pulse widths and receives reception data based on echo signals. The device includes a signal generating module for generating the two or more kinds of pulse-shaped signals. An order of two or more pulse-shaped signals included in a predetermined time frame and an order of two or more pulse-shaped signals included in a different time frame of the same length are different from each other, or else a combination of two or more pulse-shaped signals included in a predetermined time frame and a combination of two or more pulse-shaped signals included in a different time frame of the same length are different from each other. The above order of the signals included in a predetermined time frame and the pulse-shaped signals included in a different time frame of the same length are different from each other, and also the combination of the signals included in a predetermined time frame and the combination of the signals included in a different time frame of the same length can be different from each other.

The device also includes an antenna for sequentially emitting the pulse-shaped signals given from the signal generating module to the exterior and receiving echo signals, and a reception signal processing module for aligning reference timings of reception data between the same kind of pulse-shaped signals, comparing the reception data between the same kind of pulse-shaped signals, and generating data based on the comparison results.

According to another aspect of the invention, a target object detection device is provided. The device sets two or more pulse trains in which a combination and an order of two or more kinds of pulse-shaped signals of mutually different pulse widths are different from each other, transmits the two or more pulse-shaped signals for every pulse train, receives an echo signal of each pulse-shaped signal, and generates reception data. The target object detection device includes a combination of any of the transmission devices and any of the reception devices.

Therefore, in the target object detection using two or more kinds of pulse-shaped signals, secondary echoes can be suppressed. In addition, interferences due to pulse-shaped signals transmitted from other ships can also be suppressed.

The target object detection device may include an image forming module for performing image formation using the data based on the comparison results.

An image formation can be performed based on the above comparison results, thereby only a true image can be displayed on a display screen.

The antenna may revolve at a predetermined cycle.

Because the antenna revolves, the above target object detection can be performed for all directions around the target object detection device.

Note that, in the above, although only the transmission device, the reception device, and the target object detection device are described, corresponding methods may also be used, as well as computer programs for implementing the methods may also be used to obtain similar functions and effects.

### BRIEF DESCRIPTION OF THE DRAWINGS

The present disclosure is illustrated by way of example and not by way of limitation in the figures of the accompanying drawings, in which the like reference numerals indicate like elements and in which:

FIGS. 1A to 1D are views schematically showing a detection concept, a transmission concept, a reception concept, and problems of a conventional radar device;

FIG. 2 is a block diagram showing a configuration of a radar device according to a first embodiment of the invention;

FIG. 3 is a view showing a transmission concept of the radar device according to the first embodiment;

FIG. 4 is views showing pulse states of the transmission and reception of the radar device of the first embodiment, where (A) of FIG. 4 shows a transmission timing chart, (B) of FIG. 4 shows a chronological state of reception signals, and (C) of FIG. 4 shows a state where the reception signals are rearranged;

FIGS. 5A and 5B are views showing a removal concept of a secondary echo;

FIGS. 6A to 6C are views showing a removal concept of interference, where (A) of FIG. 6A shows a timing chart of transmission and reception, (B) of FIG. 6A shows a state where the reception signals are rearranged, FIG. 6B shows a data row of each sweep memory, and FIG. 6C shows a data row after interference suppression processing;

FIGS. 7A and 7B show other transmission timing charts in the radar device of the first embodiment;

FIGS. 8A and 8B show transmission timing charts of a triple pulse having a short pulse signal PS, a middle pulse signal PM, and a long pulse signal PL according to the second embodiment; and

FIGS. 9A and 9B are views illustrating a removal concept of the secondary echo in the triple pulse, where (A) of FIG. 9A shows a reception timing chart and (B) of FIG. 9A shows a state where the reception signals are rearranged, and FIG. 9B shows a data row of each sweep memory and a data row after the secondary echo suppression processing.

### DETAILED DESCRIPTION

Several embodiments of a target object detection device according to the present invention are described with reference to the accompanying drawings. Note that, below, although a radar device is illustrated as an example of the target object detection device, the configurations of the embodiments may also be applied to other devices using a pulse-shaped signal, such as a sonar device.

First, problems which the radar device of the embodiments solved are described in details using the accompanying drawings.

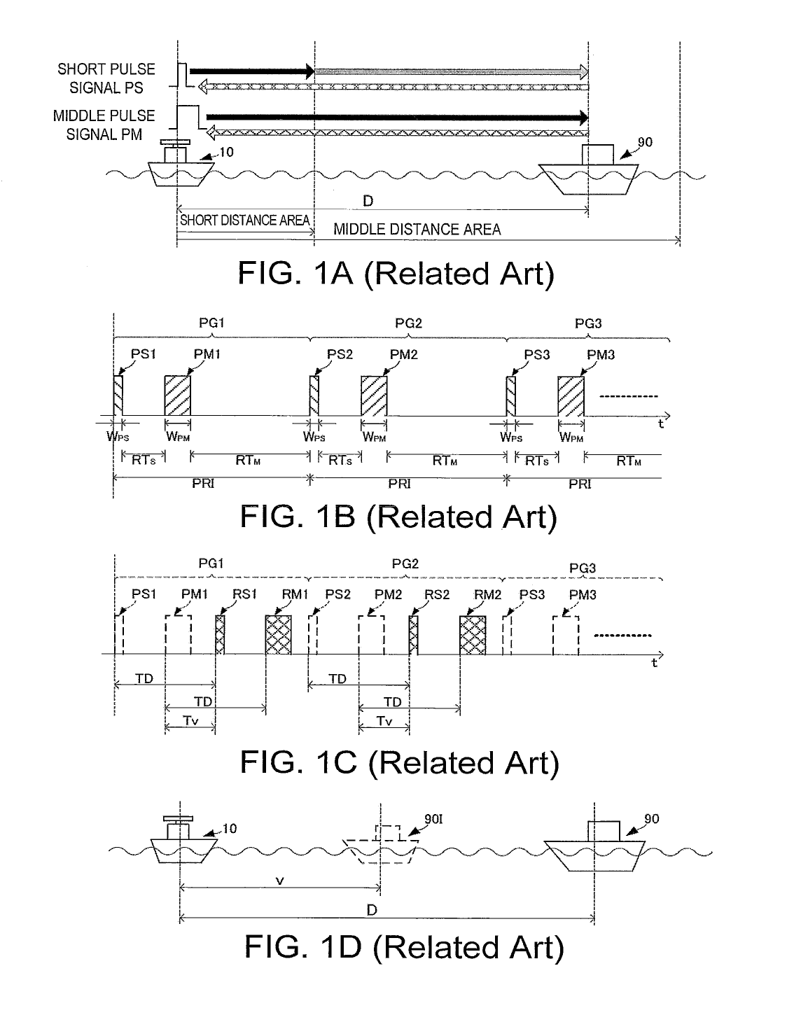

FIGS. 1A to 1D are views schematically showing a detection concept, a transmission concept, a reception concept, and problems of the conventional radar device, respectively.

As shown in FIGS. 1A and 1B, a common radar device repeatedly transmits a middle pulse signal PM for detecting a middle-distance area which is comparatively distant from a ship 10 (hereinafter, referred to as “the ship concerned” or may be simply referred to as “the ship”) within a prescribed area, and a short pulse signal PS for detecting a short-distance area which becomes a blind area due to the middle pulse signal PM. Specifically, as shown in FIG. 1B, the conventional radar device performs a transmission control for sequentially transmitting a pulse train PG at a predetermined pulse train repetition cycle PRI, which is set so that the short pulse signal PS and the middle pulse signal PM are transmitted at predetermined time intervals. Under the present circumstances, a configuration of each pulse train, a time relation between the short pulse signal PS and the middle pulse signal PM, and a standby period RT_{S} of the short pulse signal PS and a standby period RT_{M} of the middle pulse signal PM are constant regardless of the pulse train.

However, when such a conventional transmission control is performed, problems shown below may arise. That is, all of the short pulse signals PS are not necessarily reflected or attenuated in the short-distance area, but propagate also to the middle-distance area. Then, depending on situations where a reflective cross-section area of a target object 90 which exists in the middle-distance area is large and the like, the short pulse signals PS reflect on the target object 90 as shown in FIG. 1A, and the reflection signals are received by the radar device.

For this reason, as shown in FIG. 1C, true reception signals RM (RM1, RM2) caused by the middle pulse signals PM (PM1, PM2) of the target object 90 as well as reception signals RS (RS1, RS2) of secondary echoes caused by the short pulse signals PS (PS1, PS2) are received during the standby period RT_{M} of the middle pulse signals PM.

In this case, the secondary echo according to a time difference TD between a transmission timing of the middle pulse signal PM and a reception timing of the reception signal caused by the middle pulse signal, as well as a time difference Tv between a transmission timing of the middle pulse signal PM and a reception timing of the reception signal caused by the short pulse signal PS, are detected according to a true distance D between the ship 10 and the target object 90. Thus, as shown in FIG. 1D, a target object 901, which is only an image of the secondary echo, is detected as if it exists at a position of a distance v from the ship 10 where it does not exist in fact.

Because the secondary echo is generated at the same position on the time axis within a transceiving time period of all of the pulse trains PG it cannot be detected correctly and cannot be removed even if correlation processing is performed between the pulse trains.

Similarly to such a secondary echo, an interference from a radar device of another ship cannot be detected correctly and cannot be removed as well, when a transmission cycle of the radar device of other ship is the same as that of the ship concerned, even if the correlation processing is performed between the pulse trains, because the image of the interference is generated at the same position on the time axis.

### First Embodiment

A radar device of a first embodiment of the invention can suppress the image of the secondary echo and the influence of the interference at the time of performing such a target object detection using two or more kinds of pulse-shaped signals of different pulse widths. Hereinafter, a particular configuration and method thereof are described.

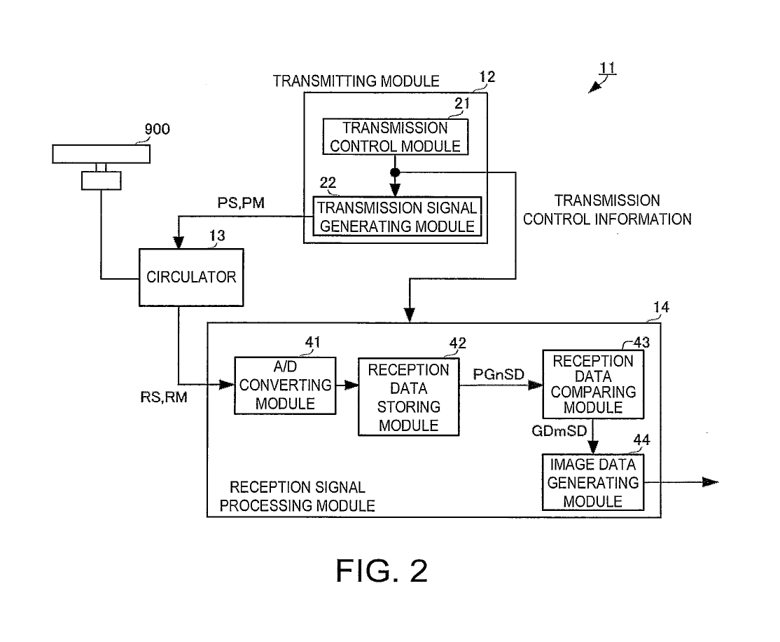

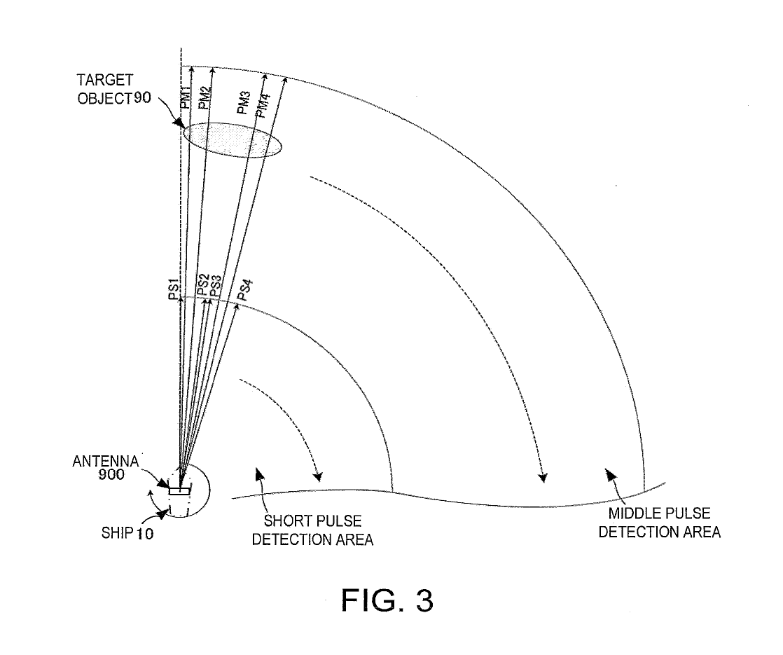

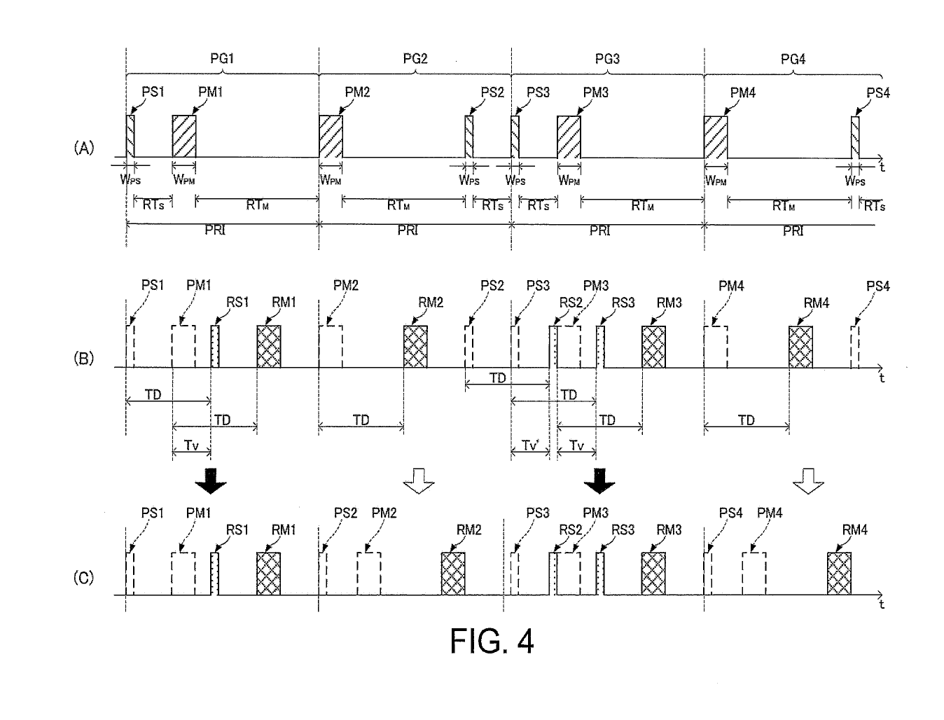

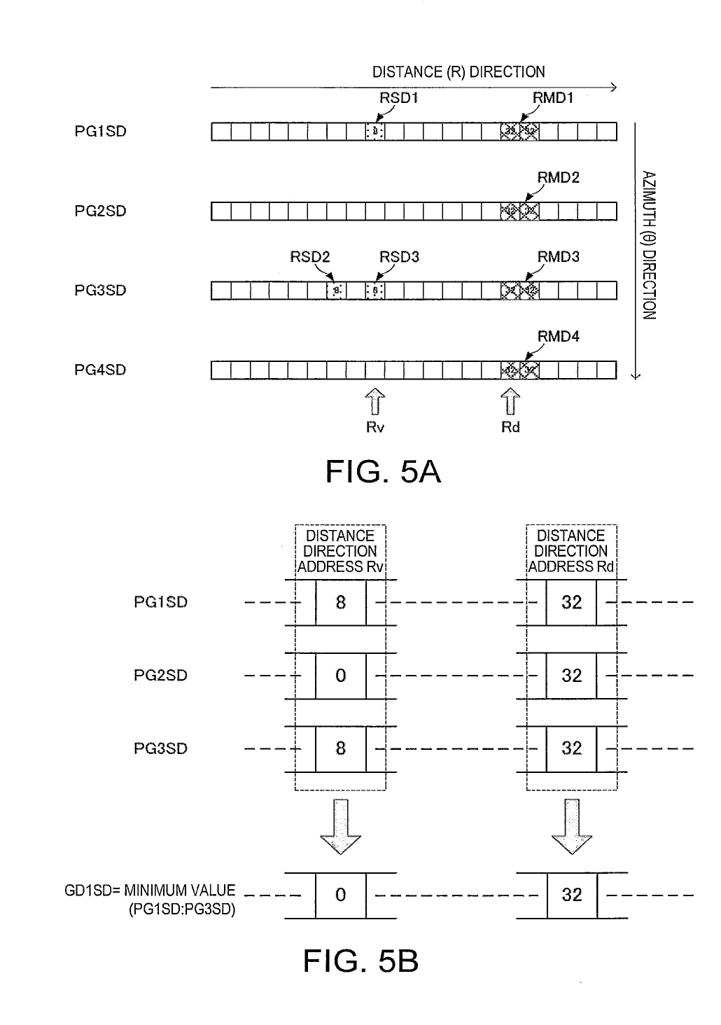

FIG. 2 is a functional block diagram of a radar device 11 of this embodiment. FIG. 3 is a view schematically showing a transmission concept. In FIG. 4, the top row (A) shows a transmission timing chart by a transmission control of this embodiment, the middle row (B) shows a chronological state of a reception signal, obtained in the situation as shown in FIG. 3 by the transmission control of (A), and the bottom row (C) shows a chronological state where the reception signals of (B) are rearranged. Note that, in FIG. 4, although the pulse trains are shown from PG1 to PG4, the pulse train PG is repeated even thereafter. FIGS. 5A and 5B are views showing a removal concept of the secondary echo, where FIG. 5A shows a data row of each sweep memory of a reception data storing module 42 of a reception signal processing module 14, and FIG. 5B shows a data row after the secondary echo removal processing.

As shown in FIG. 2, the radar device 11 of this embodiment includes a transmitting module 12 corresponding to the transmission device in the claims, a circulator 13, an antenna 900, and the reception signal processing module 14 corresponding to the reception device in the claims.

The transmitting module 12 includes a transmission control module 21 and a transmission signal generating module 22. The transmission control module 21 gives transmission control information for achieving the transmission timing chart as shown in (A) of FIG. 4, to the transmission signal generating module 22. The transmission signal generating module 22 generates the pulse train PG at a predetermined timing, which includes two kinds of pulse-shaped signals (the short pulse signal PS and the middle pulse signal PM) based on the transmission control information, and then outputs it to the circulator 13 sequentially.

Specifically, as shown in (A) of FIG. 4, the pulse train PG is constituted with one set of the short pulse signal PS and the middle pulse signal PM. The middle pulse signal PM is a pulse-shaped signal having a predetermined pulse length W_{PM} to detect a predetermined detection area. The short pulse signal PS is a pulse-shaped signal for detecting the short-distance area which becomes the blind area produced by the pulse length W_{PM} of the middle pulse signal PM. For this reason, the pulse length W_{PS} of the short pulse signal PS is set shorter than the pulse length W_{PM} of the middle pulse signal PM.

Further, in each pulse train PG, on the time axis, after the transmission of the short pulse signal PS, a standby period RT_{S} according to a distance corresponding to the maximum distant place of the short-distance area is set, and a standby period RT_{M} according to a distance corresponding to the maximum distant place of the middle-distance area (i.e., the maximum distant place of the detection area) is set after the transmission of the middle pulse signal PM. Each pulse train PG is set so that it is repeated at a fixed pulse train repetition cycle PRI.

Here, in this embodiment, it is set so that the order of the short pulse signal PS and the middle pulse signal PM is altered between the adjacent pulse trains PG on the time axis, without using a fixed order of the short pulse signal PS and the middle pulse signal PM for all the pulse trains PG. For example, as shown in (A) of FIG. 4, for the pulse trains PG1, PG2, PG3 and PG4 arranged chronologically, in the pulse train PG1, the short pulse signal PS1 and the middle pulse signal PM1 are transmitted in this order. In the pulse train PG2, the middle pulse signal PM2 and the short pulse signal PS2 are transmitted in this order. In the pulse train PG3, the short pulse signal PS3 and the middle pulse signal PM3 are transmitted in this order. In the pulse train PG4, the middle pulse signal PM4 and the short pulse signal PS4 are transmitted in this order. Note that, although this example shows the transmitting order alternates in turn for every pulse train PG, at least one pulse train PG may be set in a different transmitting order from other pulse trains PG. The transmitting order of the two or more pulse trains including the pulse trains PG which transmitting order of the short pulse signal PS and the middle pulse signal PM differs from others may be set according to a transmitting schedule set beforehand, and may be set according to a predetermined random trigger by a user's input operation or the like.

Returning to FIG. 2, the circulator 13 transmits the short pulse signal PS and the middle pulse signal PM outputted from the transmission signal generating module 22 of the transmitting module 12 to the antenna 900. The antenna 900 is equipped in the ship 10, and, as shown in FIG. 3, it emits the short pulse signal PS and the middle pulse signal PM, which are inputted via the circulator 13, to the exterior with a predetermined directivity, while rotating in a horizontal plane at a predetermined revolving speed. Thereby, as shown in FIG. 3, the short pulse signal PS and the middle pulse signal PM which constitute each pulse train PG are emitted, while the emitting azimuth direction is sequentially changed.

On the other hand, the antenna 900 receives an incoming radio wave from the outside, and outputs the reception signal to the circulator 13. The reception signal includes reflection signals of the short pulse signal PS and the middle pulse signal PM emitted from the antenna 900. The circulator 13 transmits the reception signal propagated from the antenna 900 to the reception signal processing module 14. By such a configuration, the target object detection of all directions around the ship 10 is possible.

The reception signal processing module 14 includes an A/D converting module 41, the reception data storing module 42, a reception data comparing module 43, and an image data generating module 44. The reception signal processing module 14 performs reception processing using the standby periods RT_{S} and RT_{M} where the short pulse signal PS and the middle pulse signal PM are not transmitted, as reception periods, based on the transmission control information from the transmitting module 12.

The A/D converting module 41 carries out an analog-to-digital conversion of the reception signal acquired via the circulator 13 at a predetermined sampling rate and forms reception data having a predetermined number of bits to output it to the reception data storing module 42.

The reception data storing module 42 includes a so-called “sweep memory” as shown in FIG. 5A. The reception data storing module 42 sequentially stores the reception data, which are inputted sequentially for every pulse train PG, for one sweep so that the reception data are arranged from the short distance side to the long distance side (i.e., arranged in the distance (R) direction with respect to the ship 10. Here, the reception data storing module 42 includes two or more sweep memories to store two or more sweeps arranged in the azimuth (θ) direction (i.e., the reception data of the two or more pulse trains PG). The number of sweep memories may correspond to the number of the pulse trains PG which are to be single comparison processing of comparison processing which will be described later.

As a method of storing to the particular sweep memory, the following method may be used, for example. In the pulse trains PG1 and PG3 in which the short pulse signal PS is transmitted first and the middle pulse signal PM is then transmitted, first, when the reception data of the short pulse signal PS is inputted, the reception data of the short pulse signal PS corresponding to each distance (R) is written sequentially based on the transmission timing information of the transmission control information, along the distance (R) direction, starting from a distance direction address corresponding to the nearest position in the distance (R) direction on the sweep memory to a distance direction address assigned according to the detection range of the short pulse signal PS. After that, when the reception data of the middle pulse signal PM is inputted, the reception data of the middle pulse signal PM is written sequentially according to the distance (R) in a data memory area corresponding to the pulse length W_{PM} of the middle pulse signal PM assigned away from the distance (R) range of the previous short pulse signal PS, starting from a distance direction address corresponding to the above-described nearest position based on the transmission timing information of the transmission control information.

On the other hand, in the pulse trains PG2 and PG4 where the middle pulse signal PM is transmitted first and the short pulse signal PS is transmitted next, first, when the reception data of the middle pulse signal PM is inputted, the reception data of the middle pulse signal PM is written sequentially according to each distance (R) in a data memory area corresponding to the pulse length W_{PM} of the middle pulse signal PM assigned to the middle pulse signals PM along the distance (R) direction, starting from a distance direction address corresponding to the nearest position, based on the transmission timing information of the transmission control information. Then, when the reception data of the short pulse signal PS is inputted, the reception data of the short pulse signal PS is overwritten sequentially according to each distance (R), starting from a distance direction address corresponding to the nearest position to an address assigned to the short pulse signal PS along the distance (R) direction, based on the transmission timing information of the transmission control information.

When the reception data is written in all the addresses for every sweep memory and sweep reception data PGnSD for comparison (n corresponds to the number of the pulse train PG) is accumulated, the reception data storing module 42 outputs the sweep reception data PGnSD group to the reception data comparing module 43.

The reception data comparing module 43 compares the reception data at the same distance direction address of the inputted reception data PGnSD of two or more sweeps. Then, the reception data comparing module 43 calculates minimum value data (corresponding to an example of the “representative value data” in the claims) based on two or more reception data at the target distance direction addresses. The reception data comparing module 43 forms image formation sweep data GDmSD (m is a positive integer) using the minimum value data, and outputs it to the image data generating module 44. When such comparison and minimum value calculation processing are performed, only the reception data of the true image appearing at the same distance position of the compared sweeps (i.e., at the same position on the time axis of the pulse trains for which the rearrangement processing is performed) appears in the image formation sweep data GDmSD as high level data, though this will be described later in details. On the other hand, as for the reception data of the secondary echo and interference which do not appear at the same position, the level is suppressed in the image formation sweep data GDmSD. Thereby, the influence on the reception data due to the secondary echo and interference can be suppressed.

The image data generating module 44 forms a detection image, which adjusted a luminance and a color, based on the level of each data of the inputted image formation sweep data GDmSD, and displays it on a display module (not shown). Here, because the influence of the secondary echo and interference is suppressed in the image formation sweep data GDmSD, the secondary echo and interference being displayed on the display module are suppressed and only the echo of the true target object can be displayed correctly and securely.

Next, the principle of suppressing the secondary echo and interference is described in more details.

[A] First, referring to FIGS. 3, 4, and 5A and 5B, the suppression of the secondary echo is described.

As shown in FIG. 3, in the case where a target object 90 with a large reflective cross-section area exists in the middle-distance area, when each of the pulse trains PG1-PG4 is transmitted sequentially at a transmission timing as shown in (A) of FIG. 4, the reception signals of different timings with respect to a start timing of each pulse train PG are obtained for every pulse train PG, though it is the same target object 90 as shown in (B) of FIG. 4.

### (1) Transmission and Reception by Pulse Train PG1

First, a short pulse signal PS1 of the pulse train PG1 reflects on the target object 90 which exists in the middle-distance area beyond the short-distance area which is the original target, and a reception signal RS1 is received. The reception signal RS1 is received at a timing delayed for a time length TD corresponding to the twice of a distance D between the antenna 900 (the ship 10) and the target object 90, with respect to the transmission start timing of the short pulse signal PS1. Because the reception timing of the short pulse signal PS1 is within the standby period (reception period) RT_{M} of the middle pulse signal PM1, the short pulse signal PS1 is stored in the sweep memory according to the delay time Tv from the transmission start timing of the middle pulse signal PM1.

Next, the middle pulse signal PM1 of the pulse train PG1 reflects on the target object 90 and a reception signal RM1 is received. The reception signal RM1 is received at a timing delayed for the time length TD corresponding to the twice of the distance D between the antenna 900 (the ship 10) and the target object 90, with respect to the transmission start timing of the middle pulse signal PM1.

Therefore, sweep reception data PG1SD obtained from the reception data caused by the pulse train PG1 includes, as shown in the top row of FIG. 5A, reception data RMD1 which is a true image appearing at the distance direction address corresponding to the distance D caused by the middle pulse signal PM1, and reception data RSD1 which is a secondary echo (false echo) appearing at the distance direction address corresponding to the distance v according to the short pulse signal PS1.

### (2) Transmission and Reception by Pulse Train PG2

Following the above-described pulse train PG1, a middle pulse signal PM2 of the pulse train PG2 reflects on the target object 90, and a reception signal RM2 is received. The reception signal RM2 is received at a timing delayed for the time length TD corresponding to the twice of the distance D between the antenna 900 (the ship 10) and the target object 90, with respect to the transmission start timing of the middle pulse signal PM2.

Next, the short pulse signal PS2 of the pulse train PG2 reflects on the target object 90 which exists in the middle-distance area beyond the short-distance area which is the original target, and a reception signal RS2 is received. The reception signal RS2 is received at a timing delayed for the time length TD corresponding to the twice of the distance D between the antenna 900 (the ship 10) and the target object 90, with respect to the transmission start timing of the short pulse signal PS2. The reception timing of the short pulse signal PS2 is within a period of the subsequent pulse train PG3, and is not during the period of the pulse train PG2.

Therefore, as shown in the second row of FIG. 5A, sweep reception data PG2SD obtained from the reception data caused by the pulse train PG2 includes only reception data RMD2 which is a true image appearing at the distance direction address corresponding to the distance D by the middle pulse signal PM2, but does not include reception data RSD2 which is an image of the secondary echo (false echo) by the short pulse signal PS2.

### (3) Transmission and Reception by Pulse Train PG3

Following the above-described pulse train PG2, a short pulse signal PS3 of the pulse train PG3 reflects on the target object 90 which exists in the middle-distance area beyond the short-distance area which is the original target, and a reception signal RS3 is received. The reception signal RS3 is received at a timing delayed for the time length TD corresponding to the twice of the distance D between the antenna 900 (the ship 10) and the target object 90, with respect to the transmission start timing of the short pulse signal PS3. Because the reception timing of the short pulse signal PS3 is within the standby period (reception period) RT_{M} of the middle pulse signal PM3, the short pulse signal PS3 is stored in the sweep memory according to the delay time Tv from the transmission start timing of the middle pulse signal PM3.

Next, the middle pulse signal PM3 of the pulse train PG3 reflects on the target object 90, and a reception signal RM3 is received. The reception signal RM3 is received at a timing delayed for the time length TD corresponding to the twice of the distance D between the antenna 900 (the ship 10) and the target object 90, with respect to the transmission start timing of the middle pulse signal PM3.

The reception signal RM2 of the short pulse signal PS2 of the above-described pulse train PG2 also exists during the period of the pulse train PG3.

Therefore, sweep reception data PG3SD corresponding to the pulse train PG3 includes, as shown in the third row of FIG. 5A, reception data RMD3 which is a true image appearing at the distance direction address corresponding to the distance D by the middle pulse signal PM3, reception data RSD3 which is an image of the secondary echo (false echo) appearing at the distance direction address corresponding to the distance v by the short pulse signal PS3, and the reception data RSD2 which is the image of the secondary echo (false echo) appearing by the short pulse signal PS2 of the pulse train PG2 of immediately before.

The sweep reception data PG1SD, PG2SD and PG3SD of the pulse trains PG1, PG2 and PG3 obtained in this way where the orders of the short pulse signal PS and the middle pulse signal PM are not completely in agreement with each other are compared with each other at every distance direction address. As shown in the top row, the second row, and the third row of FIG. 5A, the reception data RMD1, RMD2 and RMD3, which are the true images by the middle pulse signals PM1, PM2 and PM3, appear continuously at the same distance direction address with a predetermined level or more. On the other hand, the reception data RSD1, RSD2 and RSD3, which are the images of the secondary echoes by the short pulse signals PS1, PS2 and PS3, do not appear at the same distance direction address (i.e., at the same distance position from the ship 10).

Using the above characteristics, minimum values are acquired at every distance direction address of the sweep reception data PG1SD, PG2SD and PG3SD. By acquiring such minimum values, the level of the reception data is hardly suppressed at the distance direction address where the reception data of the middle pulse signal PM appears, and is reflected to the image formation sweep data. On the other hand, at the distance direction address where the reception data of the secondary echo of the short pulse signal PS appears, the level of the reception data is suppressed and reflected to the image formation sweep data.

For example, as shown in FIG. 5B, a case is described as an example, where the reception data of the middle pulse signal PM which is the true image appears at a distance direction address Rd and the reception data of the short pulse signal PS which is the image of the secondary echo appears at a distance direction address Rv. In this case, the reception data of the sweep reception data PG1SD, PG2SD and PG3SD at the distance direction address Rd is “32.” Therefore, data at the distance direction address Rd of image formation sweep data GD1SD which is the minimum value is not suppressed and becomes “32.” On the other hand, the reception data of the sweep reception data PG1SD and PG3 SD at the distance direction address Rv is “8,” and the reception data of the sweep reception data PG2SD is “0.” Therefore, the data of the distance direction address Rv of the image formation sweep data GD1SD which is the minimum value is suppressed and becomes “0.”

As described above, by using the processing of this embodiment, the influence by the secondary echo of the short pulse signal PS can be suppressed, without suppressing the true image caused by the middle pulse signal PM.

Note that, similarly for the pulse train PG4 and subsequent pulse trains, between the pulse trains PG to be compared, if the transmitting orders of the short pulse signal PS and the middle pulse signal PM differ, the reception data which becomes an image of the secondary echo can be suppressed, and image formation sweep data GDnSD which is constituted only with reception data according to a true image can be formed.

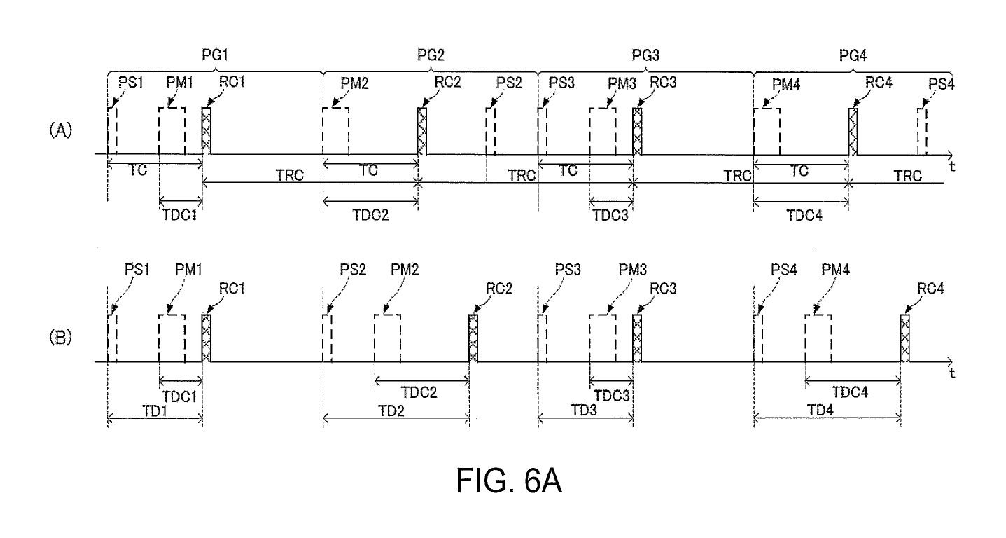

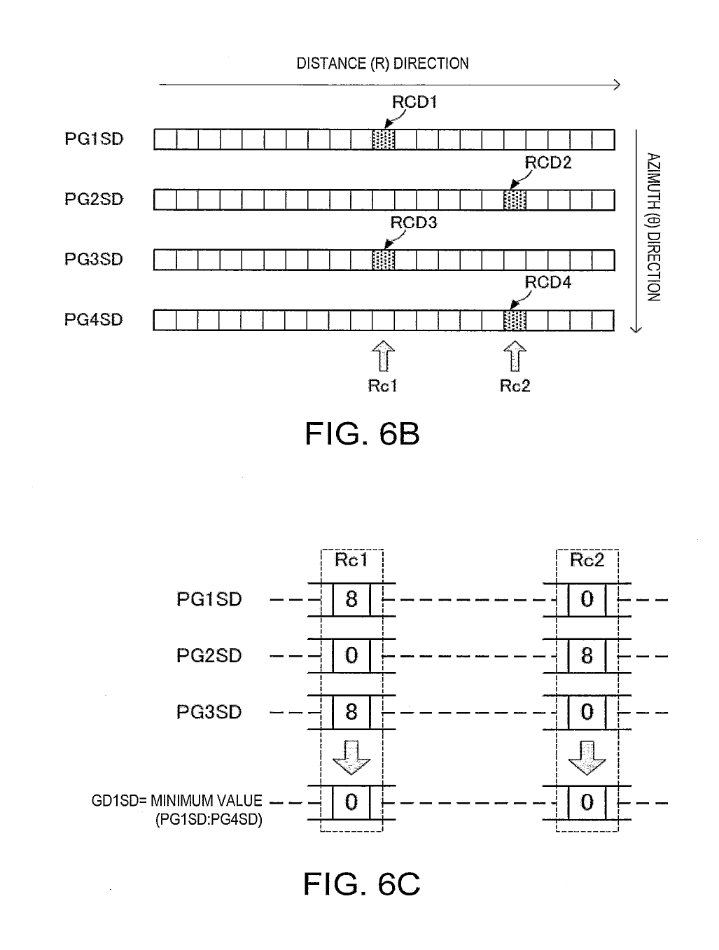

Further, in the above description, because the transmitting orders of the short pulse signal PS and the middle pulse signal PM are set to be different between the adjacent pulse trains PG on the time axis, the comparison is carried out to include the adjacent pulse trains on the time axis. However, two or more pulse trains PG to be compared are not necessary to be adjacent to each other on the time axis. It is set so that a pulse train exists in which two or more pulse trains which are the origin of the reception data to be compared are not completely in agreement with each other (that is, a transmitting order of the pulse-shaped signals of at least one of the pulse trains differs from other pulse trains).

[B] Next, referring to FIGS. 6A to 6C, the suppression of the interference is described. FIGS. 6A to 6C are views illustrating the concept of interference removal. In FIG. 6A, the part (A) shows a timing chart of transmission and reception, and the part (B) shows a timing chart of reception signal RC of the interference after the rearrangement processing of the reception signals is performed so that the orders of the short pulse signals PS and the middle pulse signals PM of the pulse trains PG are in agreement with each other. FIG. 6B shows a data row of each sweep memory, and FIG. 6C shows a data row after interference suppression processing.

When a pulse-shaped signal transmitted from another ship is received during the reception period of the ship concerned, the reception signal RC by the pulse-shaped signal of the other ship is detected. Here, if a transmission cycle TRC of the pulse-shaped signal of the other ship is in agreement with a pulse train repetition cycle PRI of the ship concerned, the reception signals RC (RC1, RC2, RC3, RC4, . . . ) due to interferences will be obtained after the same delay time TC from the start timing of each pulse train PG, respectively, as shown in (A) of FIG. 6A.

However, the pulse trains PG1 and PG3 are transmitted from the start timing of the pulse trains in order of the short pulse signal PS and the middle pulse signal PM, and the pulse trains PG2 and PG4 are transmitted from the start timing of the pulse trains in order of the middle pulse signal PM and the short pulse signal PS.

For this reason, if it is the case as shown in FIG. 6A, in the pulse train PG1 which begins from the short pulse signal PS, the delay time to the reception signal RC1 of the interference from the start timing of the short pulse signal PS is TC, but the reception signal RC1 of the interference concerned is within the reception period of the middle pulse signal PM1. Therefore, according to the delay time TDC1 from the start timing of the middle pulse signal PM1, the signal is stored in the sweep memory. Therefore, in sweep reception data PG1SD, reception data RCD1 is stored at the distance direction address according to the delay time TDC1 (≠TC) from the start timing of the middle pulse signal PM1.

Next, beginning from the middle pulse signal PM2, in the pulse train PG2 for receiving the reception signal RC2 due to interference during the reception period of the middle pulse signal PM2, the signal is stored in the sweep memory according to the delay time TDC2 which is the same as the delay time TC from the start timing of the middle pulse signal PM2. Therefore, in sweep reception data PG2SD, reception data RCD2 is stored at the distance direction address according to the delay time TDC2 (=TC) from the start timing of the middle pulse signal PM2.

Similarly, in sweep reception data PG3SD corresponding to the pulse train PG3, reception data RCD3 is stored at the distance direction address according to a delay time TDC3 (≠TC) from the start timing of the middle pulse signal PM3. In sweep reception data PG4SD corresponding to the pulse train PG4, reception data RCD4 is stored at the distance direction address according to a delay time TDC4 (=TC) from the start timing of the middle pulse signal PM4.

Then, if the sweep reception data PG1SD, PG2SD and PG3SD for the pulse trains PG1, PG2 and PG3 are compared, the reception data RCD1 and RCD3 due to interference, and the reception data RCD2 due to interference are different in the distance direction address positions. Thus, if the above-described processing for acquiring the minimum value is performed, these reception data RCD1, RCD2 and RCD3 due to interference can be suppressed at the time of formation of the image formation sweep data GD1SD.

For example, as shown in FIG. 6C, the reception data of the sweep reception data PG1SD, PG2SD and PG3SD at a distance direction address Rc1 are “8,” “0,” and “8,” respectively. Therefore, data of the image formation sweep data GD1SD at the distance direction address Rc1 which is the minimum value is suppressed and becomes “0.” The reception data of the sweep reception data PG1SD, PG2SD and PG3SD at a distance direction address Rc2 are “0,” “8,” and “0,” respectively. Therefore, data of the image formation sweep data GD1SD at the distance direction address Rc2 which is the minimum value is also suppressed and becomes “0.”

As described above, by using the processing for suppressing the secondary echo, interference can also be suppressed certainly.

As described above, by using the configuration and the method of this embodiment, even if it is a radar device for continuously transmitting two or more kinds of pulse-shaped signals, the secondary echo and interference can be suppressed certainly and a target object which actually exists can be certainly displayed according to the distance from the device to the target object.

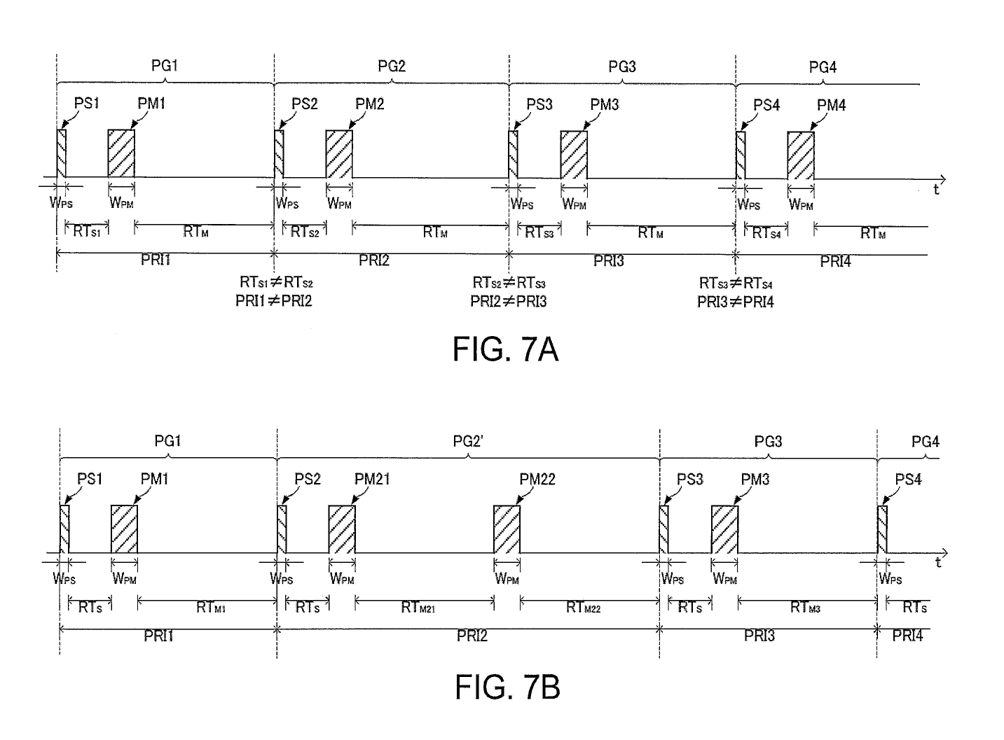

Note that, in the above description, the example is illustrated in which the transmission control using two or more pulse trains PG of which the transmitting orders of the short pulse signal PS and the middle pulse signal PM differ is performed. However, other transmission controls as shown in FIGS. 7A and 7B may also be used.

FIGS. 7A and 7B are transmission timing charts showing other examples of the transmission control of this embodiment. In the case of FIG. 7A, a transmission timing interval of the short pulse signal PS are differentiated for every pulse train PG, and in the case of FIG. 7B, the middle pulse signal PM is repeatedly transmitted in some of the pulse trains PG.

In the transmission control shown in FIG. 7A, the transmitting orders of the short pulse signal PS and the middle pulse signal PM in all of the pulse trains PG (pulse trains PG1, PG2, PG3, PG4, . . . ) are the same. However, a standby period RT_{S1} of the short pulse signal PS1 of the pulse train PG1 is made different from a standby period RT_{S2} of the short pulse signal PS2 of the pulse train PG2. In addition, the standby period RT_{S2} of the short pulse signal PS2 of the pulse train PG2 is made different from a standby time RT_{S3} of the short pulse signal PS3 of the pulse train PG3. In addition, the standby period RT_{S3} of the short pulse signal PS3 of the pulse train PG3 is made different from a standby time RT_{S4} of the short pulse signal PS4 of the pulse train PG4. Thereby, the intervals of the transmission timings of the short pulse signals PS differ.

By using the different transmission timing intervals of the short pulse signal PS as described above, the positions in the distance direction where the secondary echoes and interferences by the short pulse signals PS becomes different from each other depending on the standby period RT_{S} for respective short pulse signals PS with respect to the start timing of the pulse train PG. Therefore, by comparing the reception data caused by the pulse train PG of which the standby periods RT_{S} of the short pulse signals PS differ, the secondary echo and interference can be suppressed from appearing in the image formation sweep data.

In the transmission control shown in FIG. 7B, the pulse trains PG1 and PG3 are configured to have the same transmission timing. However, a pulse train PG2′ inserted between these on the time axis continuously transmits two middle pulse signals PM21 and PM22 having the same shape after the short pulse signal PS2.

When such a transmission control is performed, the reception signal processing module performs additional processing to the reception data of the middle pulse signal PM21 and the middle pulse signal PM22 at the time of reception of the pulse train PG2′, and stores the processed reception data in the sweep memory. For example, the reception data of the middle pulse signal PM21 is updated with the reception data of the middle pulse signal PM22, or the reception data of the middle pulse signal PM21 and the reception data of the middle pulse signal PM22 are averaged and the average is stored. Then, the additionally-processed sweep reception data of the pulse train PG2′ is compared with the sweep reception data of the pulse train PG1 or the pulse train PG3, and, thereby, the secondary echo and interference of the short pulse signal PS can be suppressed from appearing in the image formation sweep data.

Further, the above methods may be combined. That is, the transmitting orders and each standby period of the short pulse signal PS and the middle pulse signal PM which are constituent elements of the pulse train PG and the number of transmissions of the short pulse signal PS or the middle pulse signal PM may be combined suitably. Thereby, the position in the distance direction where the secondary echo of the short pulse signal PS appears and the position in the distance direction where the interference appears can be differentiated in two or more pulse trains PG, and the secondary echo and interference can be suppressed.

In this embodiment, the example in which, when the comparison processing is carried out, the minimum values of the reception data at each distance direction address of the sweep reception data of two or more pulse trains PG to be compared are used as the image formation sweep data is illustrated. However, an average value, a median, or the like may be used instead. Alternatively, in the target reception data group, a value obtained by setting reception data of a predetermined nth level from the minimum value side may also be used.

Alternatively, only when both the reception data at the same distance direction address of two or more pulse trains PG become more than a predetermined threshold, one of the reception data is set as the image formation sweep data. On the other hand, when at least either one of the reception data is less than the threshold, the image formation sweep data at the distance direction address concerned may be made to be a predetermined low value, or may be set to “0.” Alternatively, without such a determination by the threshold, one of the reception data is set only when a level difference between the reception data at the same distance direction address is less than a predetermined value, and when the level difference is greater than the predetermined value, the reception data with a lower level, or “0” may be set to the image formation sweep data. Even with these methods, the influence by the secondary echo and interference can be suppressed.

In this embodiment, the case where the sweep reception data of two pulse trains PG are compared is illustrated. However, the sweep reception data of three or more pulse trains PG may also be compared to form the image formation sweep data where the secondary echo and interference are suppressed. In this case, for example, the minimum value may be used at the same distance direction address of two or more pulse trains PG, or an average value, a median, or the like may also be used.

### Second Embodiment

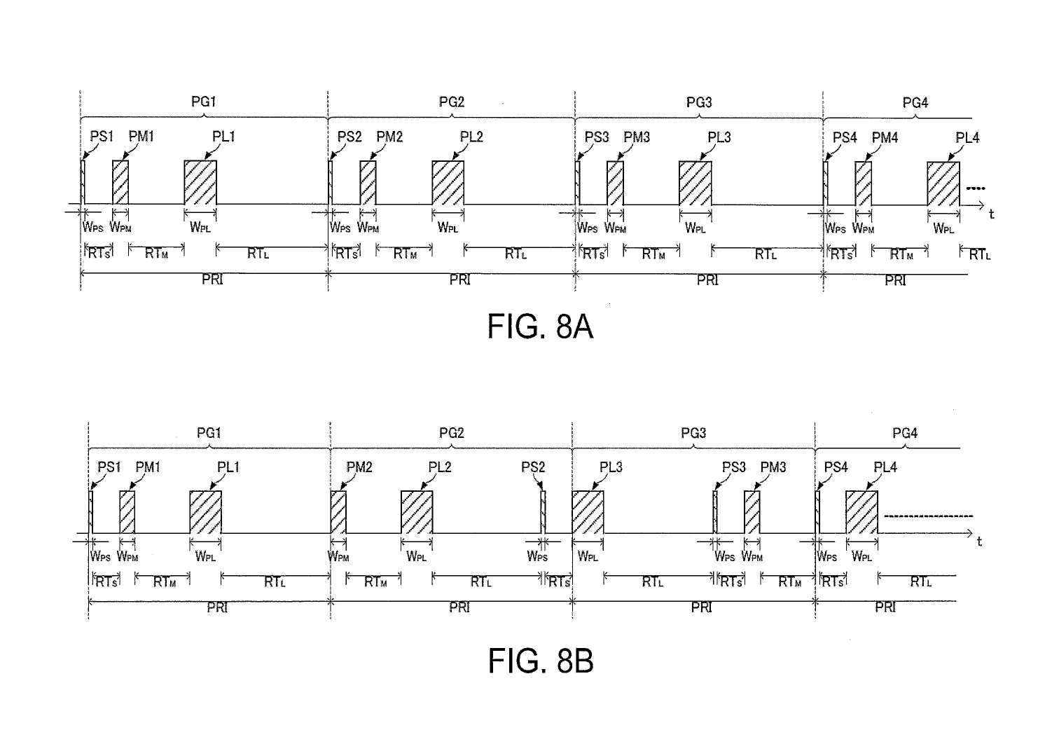

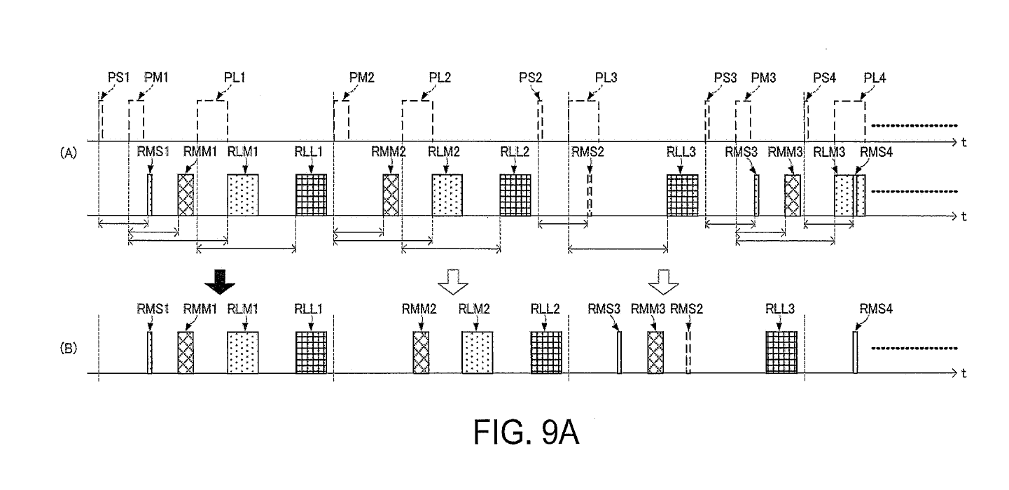

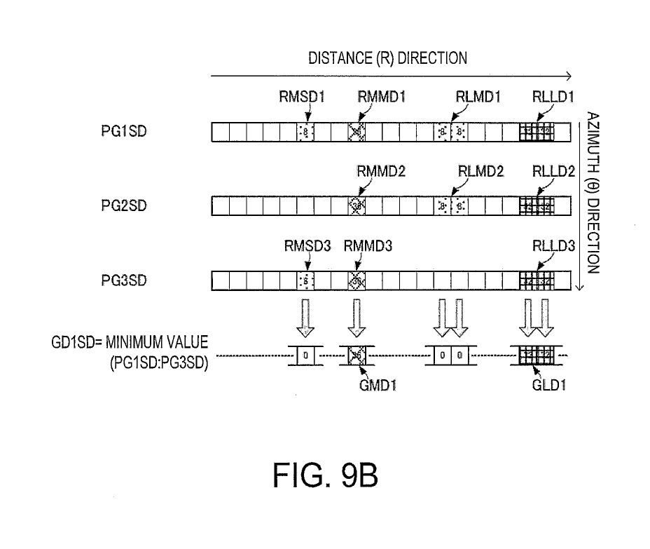

Next, a target object detection device (e.g., a radar device) according to a second embodiment of the invention is described with reference to the accompanying drawings. In this embodiment, the target object detection device has the same basic configuration as that of the first embodiment. However, the two or more kinds of pulse signals which constitute the pulse train PG are constituted with a short pulse signal PS for short-distance area, a middle pulse signal PM for middle-distance area, and a long pulse signal PL for long-distance area. Therefore, the configurational description of the device is omitted in this embodiment, and only the transmission control and the suppression concept of the secondary echo and interference are described with reference to FIGS. 8A and 8B, and FIGS. 9A and 9B.

FIGS. 8A and 8B show transmission timing charts of the triple pulse having the short pulse signal PS, the middle pulse signal PM, and the long pulse signal PL, where FIG. 8A shows a conventional transmission timing chart and FIG. 8B shows a transmission timing chart of this embodiment.

FIGS. 9A and 9B are views illustrating the suppression concept of the secondary echo in the triple pulse. In FIG. 9A, the upper chart (A) shows a reception timing chart at the time of using the transmission control of FIG. 8B, and the lower chart (B) is a view showing a chronological state where the reception signals of (A) of FIG. 9A are rearranged. In FIG. 9A, although the pulse trains are shown from PG1 to PG4, it should be appreciated that the pulse train PG is repeated for subsequent pulse trains. FIG. 9B shows a data row of each sweep memory of the reception data storing module 42 of reception signal processing module 14, and a data row after the secondary echo suppression processing.

Briefly, first, in the conventional method, the transmitting orders of the short pulse signal PS, the middle pulse signal PM, and the long pulse signal PL for all the pulse trains PG, and respective standby periods RT_{S}, RT_{M}, and RT_{L} are the same. The transmission control is carried out sequentially for these pulse trains PG at a pulse train repetition cycle PRI. In such a case, similarly for all the pulse trains PG the secondary echo of the short pulse signal PS may appear during the standby period RT_{M} after the middle pulse signal PM, or the secondary echo of the short pulse signal PS or the middle pulse signal PM may appear during the standby period RT_{L} after the long pulse signal PL. Further, the echo due to interference may appear at the same position in all the pulse trains PG. Because all the pulse trains PG have the same configuration, the second echo and interference cannot be removed even if the signals are compared between the reception data of the pulse train PG.

For this reason, in this embodiment, the transmitting orders of the short pulse signal PS, the middle pulse signal PM, and the long pulse signal PL are differentiated for every pulse train PG. For example, if it is the case of FIG. 8B, in the pulse train PG1, a short pulse signal PS1 is transmitted at the start timing of the pulse train PG1, and after the transmission, it waits for the standby period RT_{S} and a middle pulse signal PM1 is then transmitted. Further, it waits for the standby period RT_{M} after the transmission of the middle pulse signal PM1, a long pulse signal PL1 is transmitted, and after the transmission, the standby period RT_{L} is provided.

Next, in the pulse train PG2 following the pulse train PG1, a middle pulse signal PM2 is transmitted at the start timing of the pulse train PG2 (it is in agreement with the end timing of the pulse train PG1), after the transmission, it waits for the standby period RT_{M} and a long pulse signal PL2 is then transmitted. Further, it waits for the standby period RT_{L} after the transmission of the long pulse signal PL2, and a short pulse signal PS2 is then transmitted. The standby period RT_{S} is provided after the transmission.

Next, in the pulse train PG3 following the pulse train PG2, a long pulse signal PL3 is transmitted at the start timing of the pulse train PG3 (it is in agreement with the end timing of the pulse train PG2), and, after the transmission, it waits for the standby period RT_{L} and a short pulse signal PS3 is then transmitted. Further, it waits for the standby period RT_{S} after the transmission of the short pulse signal PS3, a middle pulse signal PM3 is then transmitted. The standby period RT_{M} is provided after the transmission.

Next, in the pulse train PG4 following the pulse train PG3, a short pulse signal PS4 is transmitted at the start timing of the pulse train PG4 (it is in agreement with the end timing of the pulse train PG3), and, after the transmission, it waits for the standby period RT_{S} and a long pulse signal PL4 is then transmitted. Further, it waits for the standby period RT_{L} after the transmission of the long pulse signal PL4, and a middle pulse signal PM4 is then transmitted. The standby period RT_{M} is provided after the transmission.

As described above, by differentiating the transmitting orders of the short pulse signal PS, the middle pulse signal PM, and the long pulse signal PL for every pulse train as shown in (A) of FIG. 9A, an image of the secondary echo may be obtained as the reception data together with a true image produced by each pulse signal.

For example, the example of FIGS. 9A and 9B show a case where target objects exist in the middle-distance area and the long-distance area, respectively.

### (1) During Period of Pulse Train PG1

During the standby period RT_{M} of the middle pulse signal PM1 of the pulse train PG1, a true reception signal RMM1 caused by the middle pulse signal PM1 appears along with a reception signal RMS1 of the secondary echo caused by the short pulse signal PS1. During the standby period RT_{L} of the long pulse signal PL1, a true reception signal RLL1 caused by the long pulse signal PL1 appears along with a reception signal RLM1 of the secondary echo caused by the middle pulse signal PM1.

Therefore, sweep reception data PG1SD obtained from the reception data caused by the pulse train PG1 includes, as shown in the top row of FIG. 9B, reception data RMMD1 which is a true echo appearing at a distance direction address corresponding to a target object position of the middle-distance area caused by the middle pulse signal PM1, reception data RLLD1 which is a true echo appearing at a distance direction address corresponding to a target object position of the long-distance area caused by the long pulse PL1. The sweep reception data PG1SD also includes reception data RMSD1 which is an image of the secondary echo appearing at a distance direction address corresponding to a target object position of the middle-distance area caused by the short pulse signal PS1, reception data RLMD1 which is an image of the secondary echo appearing at a distance direction address corresponding to a target object position of the long-distance area caused by the middle pulse signal PM1.

### (2) During Period of Pulse Train PG2

Next, because the short pulse signal is not transmitted immediately before, during the standby period RT_{M} of the middle pulse signal PM2 of the pulse train PG2, only a true reception signal RMM2 caused by the middle pulse signal PM2 appears. Further, during the standby period RT_{L} of the long pulse signal PL2, a true reception signal RLL2 caused by the long pulse signal PL2 appears with a reception signal RLM2 of an image of the secondary echo caused by the middle pulse signal PM2.

Therefore, sweep reception data PG2SD obtained from the reception data caused by the pulse train PG2 includes, as shown in the second row of FIG. 9B, reception data RMMD2 which is a true image appearing at a distance direction address corresponding to a target object position of the middle-distance area caused by the middle pulse signal PM2, and reception data RLLD2 which is a true image appearing at a distance direction address corresponding to a target object position of the long-distance area caused by the long pulse PL2. The sweep reception data PG2SD also includes reception data RLMD2 which is an image of the secondary echo appearing at a distance direction address corresponding to a target object position of the long-distance area caused by the middle pulse signal PM2.

### (3) During Period of Pulse Train PG3

Next, within the period of the pulse train PG3, first, a false reception signal RMS2 caused by the short pulse signal PS2 of the pulse train PG2 should appear during the transmitting period of the long pulse signal PL3. However, because it is in the transmitting period, the signal is not received and does not appear. Then, during the standby period RT_{L} of the long pulse signal PL3, because the middle pulse signal is not transmitted immediately before, only a reception signal RLL3 of a true image caused by the long pulse signal PL3 appears.

Nothing appears during the standby period RT_{S} of the short pulse signal PS3, but a reception signal RMM3 of a true image caused by the middle pulse signal PM3 appears together with a reception signal RMS3 of an image of the secondary echo caused by the short pulse signal PS3, during the standby period RT_{M} of the middle pulse signal PM3. Note that a reception signal of an image of the secondary echo of the target object of the long-distance area caused by the middle pulse signal PM3 appears during a reception period of the following pulse train PG4.

Therefore, sweep reception data PG3SD obtained from the reception data caused by the pulse train PG3 includes, as shown in the third row of FIG. 9B, reception data RMMD3 which is a true image appearing at a distance direction address corresponding to a target object position of the middle-distance area caused by the middle pulse signal PM3, and reception data RLLD3 which is a true image appearing at a distance direction address corresponding to a target object position of the long-distance area caused by the long pulse PL3. Further, the sweep reception data PG3SD also includes reception data RMSD3 which is an image of the secondary echo appearing at a distance direction address corresponding to a target object position of the middle-distance area caused by the short pulse signal PS3.

The obtained sweep reception data PG1SD, PG2SD and PG3SD of the pulse trains PG1, PG2 and PG3 of which orders of the short pulse signal PS, the middle pulse signal PM, and the long pulse signal PL differ from each other are compared for every distance direction address. As shown in the top row, the second row, and the third row of FIG. 9B, the reception data RMMD1, RMMD2 and RMMD3 which are the true images caused by the middle pulse signals PM1, PM2 and PM3 appear continuously at the same distance direction address with a predetermined level or more. On the other hand, an image of the short pulse signal PS2 does not exist at the same distance direction address as the reception data RMSD1 and RMSD3 which are the images of the secondary echoes caused by the short pulse signals PS1 and PS3, respectively.

The reception data RLLD1, RLLD2 and RLLD3 which are the true images caused by the long pulse signals PL1, PL2 and PL3 appear continuously at the same distance direction address with a predetermined level or more. On the other hand, an image of the middle pulse signal PM3 does not exist at the same distance direction address as the reception data RLMD1 and RLMD2 which are the images of the secondary echoes caused by the middle pulse signals PM1 and PM2.

Utilizing this characteristics, and if a minimum value is adopted for every distance direction address of the sweep reception data PG1SD, PG2SD and PG3SD, as shown in the bottom row of FIG. 9B, high-level image formation sweep data GD1SD can be formed at the distance direction addresses where the reception data of the middle pulse signal PM which is a true image and the reception data of the long pulse signal PL which is a true image appear.

On the other hand, levels are suppressed at the distance direction addresses where the reception data which is an image of the secondary echo of the short pulse signal PS and the reception data which is an image of the secondary echo of the middle pulse signal PM appear. The image formation sweep data GD1SD at the distance direction address concerned is formed by the data of the suppressed level. Thus, generation of the images of the secondary echo appearing in the middle-distance area caused by the short pulse signal PS and the secondary echo appearing in the long-distance area caused by the middle pulse signal PM can be suppressed. Also in this case, the interferences caused by the pulse-shaped signals of other ships can be suppressed similar to the above embodiment.

Note that, as described above, by comparing the three pulse trains of which transmitting orders are different from each other, both of the image of the secondary echo appearing in the middle-distance area and the image of the secondary echo appearing in the long-distance area can be certainly suppressed at the same time. However, depending on the combination of two pulse trains of which transmitting orders are different from each other, only the image of the secondary echo appearing in the middle-distance area can be suppressed (the combination of the sweep reception data PG1SD and PG2SD in FIG. 9B), only the image of the secondary echo appearing in the long-distance area can be suppressed (the combination of the sweep reception data PG1SD and PG3SD in FIG. 9B), or the images of the secondary echoes appearing in the middle-distance area and the long-distance area can be suppressed (the combination of the sweep reception data PG2SD and PG3SD in FIG. 9B).

In this embodiment, similar to the first embodiment, the standby time RT_{S} of the short pulse signal PS and the standby period RT_{M} of the middle pulse signal PM may be differentiated between the pulse trains PG, or the middle pulse signal PM or the long pulse signal PL may be transmitted for two or more times for specific pulse trains PG.

In the above, the triple pulse is described as an example. However, the kinds of pulse signals which constitute the pulse train PG may be four or more kinds. The above configuration and method can be applied even with the four or more kinds of pulse signals.

In this embodiment, when performing the comparison processing, the example where the minimum value of the reception data of each distance direction address of the sweep reception data of two or more pulse trains PG to be compared is used as the image formation sweep data is illustrated. However, an average value, a median value may also be used.

Further, only when both the reception data at the same distance direction address of two or more pulse trains PG becomes more than a predetermined threshold, one of the reception data may be set to the image formation sweep data, and when at least one of the reception data is less than the threshold, the image formation sweep data at the distance direction address concerned may be set to “0.” Alternatively, without such a determination based on the threshold, only when a level difference of the maximum value and the minimum value between the reception data at the same distance direction address is less than a predetermined value, the reception data of the maximum value may be set to the image formation sweep data, and when the level difference is greater than the predetermined value, the reception data of the minimum level value or “0” may be set to the image formation sweep data.

In this embodiment, the case where the sweep reception data of three pulse trains PG are compared is illustrated. However, the sweep reception data of four or more pulse trains PG may be compared to form the image formation sweep data where the secondary echoes and interferences are suppressed. In this case, a minimum value, an average value or a median value may be used at the same distance direction address of the two or more pulse trains PG.

Like this embodiment, if the number of the kinds of pulse signals in the pulse train PG increases, the number of combinations of the transmitting orders of the pulse signals also increases. Thus, for example, the sweep reception data corresponding to the number of combinations may be formed, and these may be compared. In this case, for the method of forming the image formation sweep data based on the comparison, any of the above methods may be used. The secondary echoes and interferences may be removed by arbitrarily acquiring two or more sweep reception data from these sweep reception data, and comparing them.

Note that, if the number of combinations increases as described above, two or more kinds of sweep reception data can be formed by sequentially differentiating the transmitting orders of the pulse train PG. However, target objects of which a reflection signal is small and from which reception signals of a predetermined level cannot be obtained constantly will be suppressed together with the secondary echoes and interferences. Therefore, for example, as described above, based on the levels of the reception data group at the distance direction addresses to be compared, reception data of a comparatively high level may be adopted from the target reception data group, or the number of the reception data of a predetermined level or higher may be calculated and a determination is made based on a threshold of the number. Thereby, it can prevent that such target objects with low reception levels are suppressed due to mistakenly recognizing the target objects as the secondary echoes and interferences.

Further, the configuration of each of the above embodiments and the concept of the processing are expressed functionally as follow. For every pulse train for which two or more kinds of pulse signals are transmitted sequentially, the rearrangement processing in which the transmitting orders of respective pulse signals and the time relation of the respective pulse signals are made in agreement with each other (write processing to the sweep memory) is performed to form the reception data. In this case, the configurations of the respective pulse trains may be differentiated at the time of transmission so that the image of the secondary echo appearing at the position where the image should not appear from the relation between the original pulse signal and the reception period does not appear similarly in all the pulse trains. Other configurations and methods may also be used as long as the above configuration and method can be achieved.

In the above description, the case where the shifting control of the transmitting order, the standby period, the time of repetition of the specific pulse signal and the like is set beforehand. However, a user operating interface may be additionally provided, and, by a manual input, the control of the order rearrangement and the time shifting may be suitably inserted. Alternatively, the control of the order rearrangement and the time shifting may be inserted in random. If it is under an environment where the positional information on the target objects can be acquired from other navigation devices and the like, a possibility that the secondary echoes and interferences are generated may be determined based on the positional information, and, if so, the control of the order rearrangement and the time shifting may be performed.

In the above description, the example in which the pulse train is constituted with the combination of two or more kinds of pulse-shaped signals having different pulse widths and the order and the timing of the respective pulse-shaped signals are adjusted in the pulse train is illustrated. However, without using the concept of the pulse train, the influences of the images of the secondary echoes and the interferences can be suppressed by applying the configurations and the methods of the above embodiments.

In this case, on the transmitting end, each pulse-shaped signal may be transmitted so that the temporal positional relationship of two or more kinds of pulse-shaped signals is not constantly fixed. On the other hand, on the receiving end, a reference timing adjustment of the reception data of various kinds of pulse-shaped signals may be performed by processing in which the reference timings of the reception data are synchronized between the two or more pulse-shaped signals of the same kind, without using the reference timing of the pulse train.

In the above description, the example in which the image formation sweep data is formed for every comparison result is illustrated. However, mean values, median values, minimum values, average values or the like of the data obtained from two or more comparison results may be further calculated to form the image formation sweep data.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

1. A transmission device, comprising:
a signal generating module for generating two or more kinds of pulse-shaped signals of mutually different pulse widths; and
an antenna for emitting the pulse-shaped signals to the exterior;
wherein, for the two or more kinds of pulse-shaped signals generated by the signal generating module, an order of two or more kinds of pulse-shaped signals included in a predetermined time frame differs from an order of two or more kinds of pulse-shaped signals included in a different time frame of the same length.

2. A transmission device, comprising:
a signal generating module for generating two or more kinds of pulse-shaped signals of mutually different pulse widths; and
an antenna for emitting the pulse-shaped signals to the exterior;
wherein, for the two or more kinds of pulse-shaped signals generated by the signal generating module, a combination of two or more kinds of pulse-shaped signals included in a predetermined time frame differs from a combination of two or more kinds of pulse-shaped signals included in a different time frame of the same length.

3. The transmission device of claim 1, wherein the two or more kinds of pulse-shaped signals generated by the signal generating module each uses a pulse train including every kind of pulse-shaped signal, as a unit of the predetermined time frame.

4. The transmission device of claim 2, wherein the two or more kinds of pulse-shaped signals generated by the signal generating module each uses a pulse train including every kind of pulse-shaped signal, as a unit of the predetermined time frame.

5. The transmission device of claim 3, wherein transmission timing intervals of specific two kinds of pulse-shaped signals differ in at least one of the two or more pulse trains.

6. The transmission device of claim 4, wherein transmission timing intervals of specific two kinds of pulse-shaped signals differ in at least one of the two or more pulse trains.

7. A reception device for receiving echo signals caused by two or more kinds of pulse-shaped signals of mutually different pulse widths and generating reception data, comprising:
an antenna for receiving the echo signals; and
a reception signal processing module for aligning reference timings of reception data between the same kind of pulse-shaped signals, comparing the reception data between the same kind of pulse-shaped signals, and generating data based on the comparison results.

8. A reception device, under a condition in which two or more pulse trains where a combination and an order of two or more kinds of pulse-shaped signals of mutually different pulse widths are different from each other being set, for receiving echo signals caused by the two or more pulse-shaped signals transmitted for every pulse train and generating reception data, the reception device comprising:
an antenna for receiving the echo signals;
a reception signal processing module, for the reception data of the two or more kinds of pulse-shaped signals of each pulse train, for aligning reference timings of the pulse trains and aligning each reference timing of the reception data of the two or more kinds of pulse-shaped signals that constitute the pulse train with respect to the reference timing of the pulse train, comparing the reception data between the same kind of pulse-shaped signals, and generating data based on the comparison results.

9. The reception device of claim 7, wherein the reception signal processing module includes sweep memories for individually storing the reception data for each pulse train; and
wherein the reception signal processing module mutually compares the reception data stored in the respective sweep memories, and generates data based on the comparison results.

10. The reception device of claim 7, wherein the reception signal processing module generates data based on the comparison results by adopting representative value data from the two or more reception data caused by the pulse-shaped signals of the same kind to be compared.

11. A target object detection device for emitting two or more kinds of pulse-shaped signals of mutually different pulse widths and receiving reception data based on echo signals, comprising:
a signal generating module for generating the two or more kinds of pulse-shaped signals, wherein an order of two or more pulse-shaped signals included in a predetermined time frame and an order of two or more pulse-shaped signals included in a different time frame of the same length are different from each other;
an antenna for sequentially emitting the pulse-shaped signals given from the signal generating module to the exterior and receiving echo signals; and
a reception signal processing module for aligning reference timings of reception data between the same kind of pulse-shaped signals, comparing the reception data between the same kind of pulse-shaped signals, and generating data based on the comparison results.

12. A target object detection device for emitting two or more kinds of pulse-shaped signals of mutually different pulse widths and receiving reception data based on echo signals, comprising:
a combination of two or more pulse-shaped signals included in a predetermined time frame and a combination of two or more pulse-shaped signals included in a different time frame of the same length are different from each other;
an antenna for sequentially emitting the pulse-shaped signals given from the signal generating module to the exterior and receiving echo signals; and
a reception signal processing module for aligning reference timings of reception data between the same kind of pulse-shaped signals, comparing the reception data between the same kind of pulse-shaped signals, and generating data based on the comparison results.

13. A target object detection device for setting two or more pulse trains in which a combination and an order of two or more kinds of pulse-shaped signals of mutually different pulse widths are different from each other, transmitting the two or more pulse-shaped signals for every pulse train, receiving an echo signal of each pulse-shaped signal, and generating reception data, the target object detection device comprising:
a transmission device
a signal generating module for generating two or more kinds of pulse-shaped signals of mutually different pulse widths, and
an antenna for emitting the pulse-shaped signals to the exterior,
wherein, for the two or more kinds of pulse-shaped signals generated by the signal generating module, a combination of two or more kinds of pulse-shaped signals included in a predetermined time frame differs from a combination of two or more kinds of pulse-shaped signals included in a different time frame of the same length; and
wherein the two or more kinds of pulse-shaped signals generated by the signal generating module each uses a pulse train including every kind of pulse-shaped signal, as a unit of the predetermined time frame; and
a reception device for receiving echo signals caused by two or more kinds of pulse-shaped signals of mutually different pulse widths and generating reception data, including,
an antenna for receiving the echo signals, and
a reception signal processing module for aligning reference timings of reception data between the same kind of pulse-shaped signals, comparing the reception data between the same kind of pulse-shaped signals, and generating data based on the comparison results.

14. (canceled)

15. The target object detection device of claim 13, comprising an image forming module for performing image formation using the data based on the comparison results.

16. (canceled)

17. The target object detection device of claim 15, wherein the antenna revolves at a predetermined cycle.

18. (canceled)

19. A method of target detection, comprising:
generating the two or more kinds of pulse-shaped signals, wherein an order of two or more kinds of pulse-shaped signals included in a predetermined time frame and an order of two or more kinds of pulse-shaped signals included in a different time frame of the same length are different from each other;
sequentially emitting the two or more kinds of pulse-shaped signals to the exterior;
receiving echo signals caused by two or more kinds of pulse-shaped signals of mutually different pulse widths and generating reception data; and
aligning reference timings of reception data between the same kind of pulse-shaped signals, comparing the reception data between the same kind of pulse-shaped signals, and generating data based on the comparison results.

20. A method of target detection, comprising:
generating the two or more kinds of pulse-shaped signals, wherein a combination of two or more kinds of pulse-shaped signals included in a predetermined time frame and a combination of two or more kinds of pulse-shaped signals included in a different time frame of the same length are different from each other;
sequentially emitting the two or more kinds of pulse-shaped signals to the exterior;
receiving echo signals caused by two or more kinds of pulse-shaped signals of mutually different pulse widths and generating reception data; and
aligning reference timings of reception data between the same kind of pulse-shaped signals, comparing the reception data between the same kind of pulse-shaped signals, and generating data based on the comparison results.

21. The target detection device of claim 13, wherein the two or more kinds of pulse-shaped signals generated by the signal generating module each uses a pulse train including every kind of pulse-shaped signal, as a unit of the predetermined time frame.

22. The target object detection device of claim 21, comprising an image forming module for performing image formation using the data based on the comparison results.

23. The target object detection device of claim 22, wherein the antenna revolves at a predetermined cycle.
